(19) United States
(12) Patent Application Publication
(10) Pub. No.: US 2008/0041860 A1
(43) Pub. Date: Feb. 21, 2008

(54) Three-layered containers and methods of making the same

(75) Inventors: Warren G. Wiedmeyer, Slinger, WI (US); David Shiltz, Columbus, OH (US)

Correspondence Address: PACTIV CORPORATION;c/o NIXON PEABODY LLP, 161 N. CLARK STREET, 48TH FLOOR, CHICAGO, IL, 60601-3213, US

(73) Assignee: Pactiv Corporation

(21) Appl. No.: 11/894,228

(22) Filed: Aug. 20, 2007

Related U.S. Application Data
(60) Provisional application No. 60/839,039, filed on Aug. 21, 2006.

(51) Int. Cl. B65D 81/38; B31B 1/00

(52) U.S. Cl. 220/592.26; 220/592.2; 493/84

(57) ABSTRACT

A thermally insulated container is disclosed. The container comprises an inner layer having a bottom portion with a bottom closure attached to the bottom portion. The container further comprises an outer layer wrapped around the inner layer. The container further comprises an insulating middle layer sandwiched between the inner layer and the outer layer. The container further comprises a side seam including five or less layers. At least one of the layers of the side seam is an end of the middle layer.

### CROSS-REFERENCE TO RELATED APPLICATION

This application claims the benefit of U.S. Provisional Application No. 60/839,039, filed Aug. 21, 2006, which is hereby incorporated by reference in its entirety.

### FIELD OF THE INVENTION

The present invention relates generally to disposable containers and, more particularly, to insulated disposable containers and/or cups and methods of manufacturing the same.

### BACKGROUND OF THE INVENTION

Some types of disposable cups that are typically used for holding beverages include those comprised of polystyrene, expanded polystyrene, and paper. Although polystyrene cups are aesthetically pleasing, they provide little, if any, insulation and are, therefore, mainly used for holding cold drinks. Condensation may form on the outside of a polystyrene cup containing a cold drink, thereby making the cup wet, cold, and/or uncomfortable to use and/or hold for prolonged periods of time. The condensation may also make the polystyrene cup slippery, thus making the cup even more difficult and/or uncomfortable to hold. Another drawback of polystyrene cups is that they are environmentally unfriendly because they are neither biodegradable nor easily recyclable.

A second type of cup, comprised of expanded polystyrene, or EPS (e.g., a Styrofoam® cup), is an excellent thermal insulator and may, thus, maintain the temperature of a drink—whether hot or cold—for extended periods of time. Expanded polystyrene cups are generally inexpensive and comfortable to handle because their exteriors stay close to ambient temperature regardless of the temperature of the beverage inside the cup. One drawback of expanded polystyrene cups, however, is that they are environmentally unfriendly because expanded polystyrene is neither biodegradable nor easily recyclable. As a result, the use of expanded polystyrene cups has been banned in some municipalities. Additionally, because the expanded polystyrene cups must be printed after they have been formed and their rough surface does not allow high-resolution printing, a slow and costly process must be used for printing on expanded polystyrene cups.

Standard, single-wall paper cups are generally recyclable and biodegradable and are, therefore, considered environmentally sound. However, paper cups are relatively poor thermal insulators, and, thus, a beverage in a paper cup quickly warms (if cold) or cools (if hot). Paper cups are also generally uncomfortable to handle because a hot or cold drink may uncomfortably cool or heat a hand. Additionally, as with polystyrene cups, a cold drink may cause condensation to appear on the outside of the paper cup, making the cup slippery and/or difficult to hold. Furthermore, the single-wall construction of paper cups makes them particularly fragile, and, thus, paper cups filled with liquid may crumble after prolonged handling.

Multi-layered paper cups have been designed to provide thermal insulation and increased strength, which are often lacking in single-layered paper cups. Multi-layered cups generally comprise several layers including an outer layer, a middle insulating layer, and an inner layer. Although generally strong and thermally efficient, multi-layered cups may be expensive and impractical to manufacture.

In some existing multi-layered cups, the inner layer and the outer layer are formed from a single sheet. The single sheet may then be folded over to form the inner layer and the outer layer. This approach may be undesirable because it may result in a substantial amount of wasted materials, particularly in embodiments where the height of the outer layer is less than the height of the inner layer. Furthermore, forming the inner layer and the outer layer from the same sheet necessitates that the inner layer and the outer layer be comprised of the same material and/or coating. This may be undesirable because the materials and/or thicknesses of the different layers may not be altered to achieve desired properties of the cup including insulating ability, weight, strength, percentage of recyclable material, cost of material, and the like. Furthermore, if a “legend” is to be printed on the inner ring of the bottom of the cup, the “fold-over” approach may require printability on both sides of the single sheet, which may further increase manufacturing costs of the multi-layered cup.

It would be desirable to provide a multi-layered container or cup that assists in addressing one or more of the above disadvantages.

### SUMMARY OF THE INVENTION

According to one embodiment of the present invention, a thermally insulated container is disclosed. The container comprises an inner layer having a bottom portion with a bottom closure attached to the bottom portion. The container further comprises an outer layer wrapped around the inner layer. The container further comprises an insulating middle layer sandwiched between the inner layer and the outer layer. The container further comprises a side seam including five or less layers. At least one of the layers of the side seam is an end of the middle layer.

According to one process of the present invention, a method of making a thermally insulated container is disclosed. The method comprises the act of providing a bottom blank, an inner layer, an outer layer, and a middle layer. The middle layer comprises an insulating sheet material. The method further comprises the act of stacking the inner layer, the outer layer, and the middle layer such that the middle layer is sandwiched between the inner layer and the outer layer to form a layered arrangement. The layered arrangement has a first end and an opposing second end. The method further comprises the act of wrapping the layered arrangement such that the first end overlaps the second end to form an overlapping portion. The method further comprises the act of sealing at least part of the overlapping portion to form a side seam having five or less layers. At least one of the layers of the side seam is an end of the middle layer.

According to another embodiment of the present invention, a thermally insulated container is disclosed. The container comprises an inner layer having a bottom portion with a bottom closure attached to said bottom portion. The container further comprises an outer layer wrapped around said inner layer. The container further comprises an insulating middle layer sandwiched between the inner layer and the outer layer. The container further comprises a side seam comprising five or less layers. At least one end of the outer layer is sealed with at least one end of the inner layer at the side seam.

According to another embodiment of the present invention, a thermally insulated container is disclosed. The container comprises an inner layer having a bottom portion with a bottom closure attached to the bottom portion. The container further comprises an outer layer wrapped around the inner layer. The container further comprises an insulating middle layer sandwiched between the inner layer and the outer layer. The container further comprises a side seam including six layers, the six layers comprising a first end and a second end of the inner layer, a first end and a second end of the middle layer, and a first end and a second end of the outer layer.

The above summary of the present invention is not intended to represent each embodiment or every aspect of the present invention. Additional features and benefits of the present invention are apparent from the detailed description and figures set forth below.

### BRIEF DESCRIPTION OF THE DRAWINGS

FIG. 1 is a cross-sectional, elevational view of a cup made according to one embodiment of the present invention.

FIG. 2a is a top view of sheet blanks used for making a cup in accordance with an embodiment of the present invention.

FIG. 2b is a side view of a middle layer blank according to one embodiment.

FIG. 2c is a top view of a three-layered arrangement formed using the blanks of FIG. 2a.

FIG. 3a is a top view of a three-layered arrangement of blanks according to another embodiment of the present invention.

FIG. 3b is a top, cross-sectional view of a cup formed using the three-layered arrangement of FIG. 3a.

FIG. 3c is a blown-up view generally of section A of FIG. 3b according to one embodiment.

FIG. 3d is a blown-up view generally of section A of FIG. 3b according to another embodiment.

FIG. 3e shows section A of FIGS. 3b and 3c after a side seam has been sealed.

FIG. 3f shows section A of FIG. 3e having a waterproof coating applied to surfaces of several layers of the cup according to one embodiment.

FIG. 3g shows section A of FIG. 3e having a waterproof coating applied to surfaces of several layers of the cup according to another embodiment.

FIG. 4a is a top view of a three-layered arrangement of blanks according to another embodiment of the present invention.

FIG. 4b is a top, cross-sectional view of a cup formed using the three-layered arrangement of FIG. 4a.

FIG. 4c is a blown-up view generally of section B of FIG. 4b.

FIG. 4d shows section B of FIGS. 4a and 4b after a side seam has been sealed according to one embodiment.

FIG. 5a is a top view of a three-layered arrangement of blanks according to another embodiment of the present invention.

FIG. 5b is a top, cross-sectional view of a cup formed using the three-layered arrangement of FIG. 5a.

FIG. 5c is a blown-up view generally of section C of FIG. 5b.

FIG. 5d shows section C of FIGS. 5a and 5b after a side seam has been sealed.

FIG. 6a is a top view of a three-layered arrangement of blanks according to another embodiment of the present invention.

FIG. 6b is a top, cross-sectional view of a cup formed using the three-layered arrangement of FIG. 6a.

FIG. 6c is a blown-up view generally of section D of FIG. 6b.

FIG. 6d shows section D of FIGS. 6a and 6b after a side seam has been sealed.

FIG. 7a is a top view of a three-layered arrangement of blanks according to another embodiment of the present invention.

FIG. 7b is a top, cross-sectional view of a cup formed using the three-layered arrangement of FIG. 7a.

FIG. 7c is a blown-up view generally of section E of FIG. 7b.

FIG. 7d shows section E of FIGS. 7a and 7b after a side seam has been sealed.

FIG. 8a is a side view of a three-layered arrangement of blanks according to another embodiment of the present invention.

FIG. 8b is a top, cross-sectional view of a cup formed using the three-layered arrangement of FIG. 8a.

FIG. 8c is a blown-up view of section F of FIG. 8b according to one embodiment.

FIG. 8d shows section F of FIGS. 8a and 8b after a side seam has been sealed according to one embodiment.

FIG. 8e shows section F of FIGS. 8a and 8b after a side seam has been sealed according to another embodiment.

FIG. 8f is a blown-up view of section F of FIG. 8b according to another embodiment.

FIG. 8g shows section F of FIG. 8f after a side seam has been sealed.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATED EMBODIMENTS

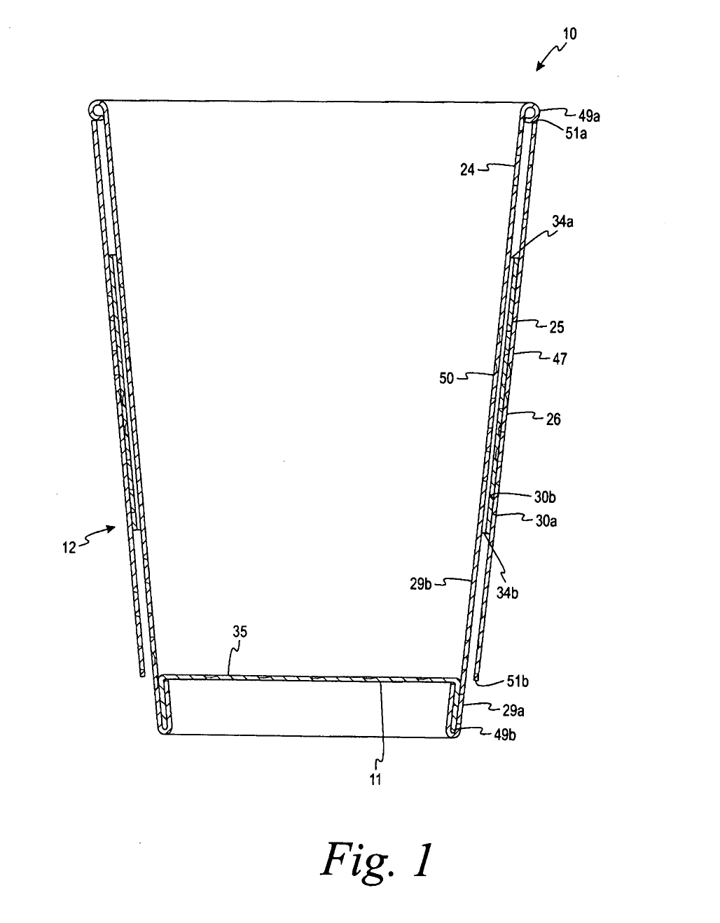

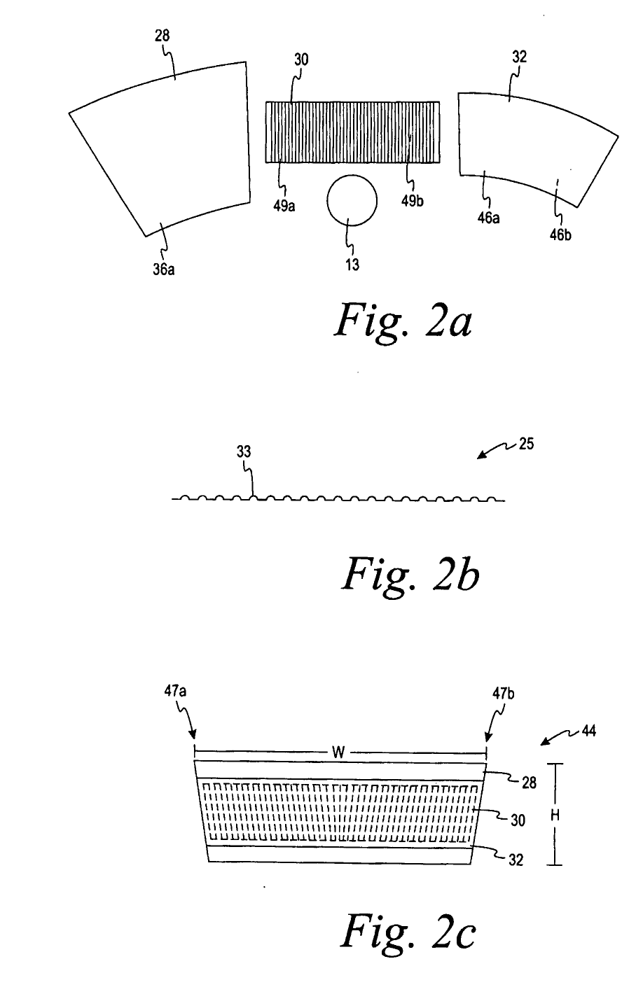

Referring to FIG. 1, a cup 10 is shown in accordance with one embodiment of the present invention. The cup 10 includes bottom 11 and a sidewall 12. The sidewall 12 comprises an inner layer 24, an insulating middle layer 25, and an outer layer 26. The bottom 11 is formed from a bottom blank 13, as shown in FIG. 2a.

The inner layer 24 may comprise various types of suitable materials. Non-limiting examples of materials that may be used to form the inner layer 24 include, flat, unscored paperboard such as chipboard (plain chip or bending chip), linerboard, virgin paperboard, paperboard with recycled content, solid bleach sulfite (SBS) board, solid unbleached sulfite (SUS) board, polymeric solid sheets, combinations thereof, or the like. The inner layer 24 may further be comprised of foil or metalized film laminated paperboard, porous sheets, foam sheets (e.g., expanded polystyrene), combinations thereof, or the like. Although the thickness of the inner layer 24 generally depends on the type and/or application of the resulting cup 10, the thickness of the inner layer 24 is generally from about I mil to about 20 mils. More typically, the thickness of the inner layer 24 is generally from about 5 mils to about 10 mils. It is contemplated that the inner layer 24 may also have other thicknesses.

Alternatively or additionally, a front side 29a, a back side 29b, or both the front side 29a and the back side 29b of the inner layer 24 may be coated with a waterproof material including, for example, plastic. It may be desirable for the back side 29b of the inner layer 24 to include the waterproof material to assist in preventing or inhibiting a liquid held inside of the cup 10 from seeping into or through the sidewall 12. One non-limiting example of such a waterproof material is polyethylene (low, medium, or high density), which may serve as both an adhesive and a waterproof coating. Furthermore, a polyethylene coating generally provides a printable surface. Although the embodiments of the present invention are generally described herein as having a polyethylene coating, it is contemplated that other suitable coatings may also be used with any of the embodiments of the present invention. For example, other types of waterproof and heat sealable coatings that may be used include, but are not limited to, polypropylene, foamed polyethylene, other foamed polymers, polyester, polyolefins, other types of biodegradable, recyclable, waterproof and/or heat sealable coatings, combinations thereof, or the like. The thickness of the waterproof coating is generally from about 0.5 mils to about 1.5 mils. It is contemplated that the waterproof coating may also have other thicknesses. The coating may have a matte finish, a gloss finish, or an intermediate, semi-gloss type finish. Any suitable method of applying the coating may be used including, but not limited to press applying the waterproof coating. It is contemplated that the inner layer 24 may comprise two-sided polyethylene sheets such that the inside of the cup 10 is waterproofed and provides the outside of the cup 10 with a coated printable surface on the front side 29a.

Similarly, the outer layer 26 may comprise various types of suitable materials. Non-limiting examples of materials that may be used to form the outer layer 26 include unscored paperboard such as chipboard (plain chip or bending chip), linerboard, virgin paperboard, paperboard with recycled content, SBS board, SUS board, polymeric solid sheets, combinations thereof, or the like. The outer layer 26 may further be comprised of foil or metalized film laminated paperboard, porous sheets, foam sheets (e.g., expanded polystyrene), combinations thereof, or the like. Alternatively or additionally, a front side 30a, a back side 30b, or both the front side 30a and the back side 30b of the outer layer 26 may be coated with a waterproof coating including, for example, polyethylene. Although the thickness of the outer layer 26 generally depends on the type and/or application of the resulting cup 10, the thickness of the outer layer 26 is generally from about 1 mil to about 20 mils. More typically, the thickness of the outer layer 26 is generally from about 5 mils to about 10 mils. It is contemplated that the outer layer 26 may also have other thicknesses. Although not shown in the illustrated embodiments, the outer layer 26 may include ribs, an array of dimples, corrugations, scores, combinations thereof, or the like to increase insulation and/or to provide an enhanced surface for gripping.

The insulating middle layer 25 may comprise any suitable material. For example, the insulating middle layer 25 may comprise flat, unscored paperboard such as chipboard (plain chip or bending chip), linerboard, virgin paperboard, paperboard with recycled content, SBS board, SUS board, polymeric sheets, combinations thereof, or the like. The middle layer 25 may further be comprised of scored foil, or metalized film laminated paperboard, porous sheets, foam sheets (e.g., expanded polystyrene), fluted paperboard sheet, a water-soluble (e.g., starch-based) material, a paperboard sheet with a foamed heat-insulating layer coating (e.g., polyethylene, polyolefin, polyvinylchloride, polystyrene, polyester, or nylon), combinations thereof, or the like. The thickness of the middle layer 25 is generally from about 2 mils to about 15 mils. More typically, the thickness of the middle layer 25 is generally from about 5 mils to about 10 mils. It is contemplated that the middle layer 25 may also have other thicknesses.

The middle layer 25 generally includes spaced grooves, scores, or corrugations 33 (see FIG. 2b) formed into its surface. The corrugations 33 provide air space within the sidewall 12 of the cup 10. The corrugations 33 of the illustrated embodiments extend substantially from a top edge 34a to a bottom edge 34b of the middle layer 25. The corrugations 33 may be positioned from about 115 mils to about 515 mils apart and may range from about 5 mils to about 30 mils deep. It is contemplated that the corrugations 33 may be positioned other distances apart and/or may have various other depths. The corrugations 33 may be formed by any suitable die operation(s). In one embodiment, the corrugations 33 are formed into a sheet while cutting the sheet from a larger starting sheet. The corrugations 33 may also be formed prior to or after cutting the sheet. In an alternative embodiment, instead of corrugations running from top to bottom, the corrugations are positioned to run sideways (i.e., from left to right), diagonally, or the like. Furthermore, instead of corrugations 33, it is contemplated that embossed dimples or any other type of integral deformities may be formed into the sheet.

The bottom 11 may comprise various types of suitable materials. Non-limiting examples of materials that may be used to form the bottom 11 include unscored paperboard such as chipboard (plain chip or bending chip), linerboard, virgin paperboard, paperboard with recycled content, SBS board, SUS board, polymeric solid sheets, combinations thereof, or the like. The bottom 11 may further be comprised of foil or metalized film laminated paperboard, porous sheets, foam sheets (e.g., expanded polystyrene), combinations thereof, or the like. The thickness of the bottom 11 is generally from about 1 mil to about 20 mils. More typically, the thickness of the bottom 11 is generally from about 5 mils to about 15 mils. It is contemplated that the bottom 11 may also have other thicknesses. It is further contemplated that the bottom 11 may be coated on at least an inner surface 35 with a waterproof material including those described above with respect to the inner layer 24.

Each of the inner layer 24, the middle layer 25, and the outer layer 26 is formed from a corresponding inner layer blank 28, middle layer blank 30, and outer layer blank 32, as shown in FIG. 2a. Each of the blanks 28, 30, 32 may be die cut from a separate, corresponding larger sheet or roll (not shown) of paper or other suitable sheet material.

The inner layer blank 28 and the outer layer blank 32 are generally tapered to form the corresponding inner layer 24 and outer layer 26 of the sidewall 12 of the cup 10. In general, when making straight-walled containers using techniques of the present invention, the sidewall blanks should be generally straight rather than tapered as in FIG. 2a.

In the illustrated embodiment, the middle layer 25 is corrugated, thus allowing portions of the middle layer 25 to be stretched or compressed when wrapped to form the cup 10. Therefore, the middle layer blank 30 may have various shapes including rectangular, as shown in the embodiment of FIG. 2a.

The dimensions of the inner layer blank 28, the middle layer blank 30, and the outer layer blank 32 generally depend on the desired dimensions of the resulting cup 10. The width W of the blanks 28, 30, 32 may, for example, range from about 4 inches to about 24 inches. It is also contemplated, however, that the blanks 28, 30, 32 may have other widths. Because the outer layer 26 of the cup 10 has a slightly larger circumference than the middle layer 25, the outer layer blank 32 is generally slightly wider than the middle layer blank 30. Similarly, because the middle layer 25 has a slightly larger circumference than the inner layer 24, the middle layer blank 30 is generally slightly wider than the inner layer blank 28.

The height H of each of the blanks 28, 30, 32 may generally range from about 2 inches to about 10 inches. According to the illustrated embodiment of FIG. 2a, the inner layer blank 28 has a greater height (i.e., is taller) than the middle layer blank 30 and the outer layer blank 32. This may be desirable so that less materials are used, thereby decreasing the cost of manufacturing the resulting cup 10. In embodiments where the outer layer blank 32 and/or the middle layer blank 30 have smaller heights than the inner layer blank 28, the blanks 28, 30, 32 should be stacked such that at least the middle portion 25 is generally located on an area of the sidewall 12 that is likely to be grasped by a user. For example, the middle portion 25 may be generally centrally located relative to the height of the cup 10. It is contemplated that the blanks and corresponding layers of the cups or containers of the present invention may also have other heights relative to one another.

After each of the inner layer blank 28, the middle layer blank 30, and the outer layer blank 32 are cut and formed, they are assembled to form the sidewall 12 (FIG. 1). To form the sidewall 12, the outer layer blank 32, the middle layer blank 30, and the inner layer blank 28 are stacked to form a flat, three-layered arrangement 44, as shown in FIG. 2c. The middle layer blank 30 is sandwiched between the outer layer blank 32 and the inner layer blank 28 such that a front side 46a of the outer layer blank 32 forms an outside surface 47 of the cup 10 and the back side 46b of the inner layer blank 28 forms an inside surface 50 of the cup (FIG. 1).

The middle layer blank 30 may be glued, bonded, or otherwise fastened to the inner layer blank 28 and/or the outer layer blank 32. For example, the middle layer blank 30 may be attached to the inner layer blank 28 and the outer layer blank 32 by dabbing small amounts of adhesive (e.g., hot melt adhesive) periodically along the length of either or both sides 49a,b of the middle layer blank 30. Alternatively or additionally, the small amounts of adhesive may be dabbed periodically along the length of a front side 36a of the inner layer blank 28 and/or along the back side 46b of the outer layer blank 32. Because the outer layer 26 generally has a slightly larger circumference than the middle layer 25 and the inner layer 24 (as described above), the outer layer blank 32 slides relative to the middle layer blank 30 and the inner layer blank 28 when the three-layered arrangement 44 is wrapped to form the sidewall 12. Thus, dabbing the adhesive periodically along the length of the blank(s) 28, 30, 32 fastens the blanks 28, 30, 32 such that the outer layer blank 32 may slide relative to the inner layer blank 28 to assist in preventing the resulting sidewall 12 from becoming distorted. In embodiments where the middle layer blank 30 is fastened to only one of the inner layer blank 28 or the outer layer blank 32, it may be desirable for the inner layer blank 28 to be fastened to the outer layer blank (e.g., at an end 47a, 47b) such that each layer 28, 30, 32 is at least indirectly attached to the other layers 28, 30, 32. The adhesive serves to maintain the blanks 28, 30, 32 in the flat, three-layered arrangement 44 of FIG. 2c prior to assembling the cup 10 and to assist in preventing shifting of the individual blanks 28, 30, 32. The adhesive may also assist in maintaining the resulting cup 10 in an assembled state.

After the three-layered assembly 44 is formed, it may then be wrapped to form the sidewall 12 of the cup. According to one embodiment, the three-layered arrangement 44 is wrapped or bent around a known tapered mandrel (not shown) to form the sidewall 12, which includes the inner layer 24, the middle layer 25, and the outer layer 26. It is contemplated that other methods of wrapping the three-layered assembly 44 may also be used. A first end 47a of the three-layered arrangement 44 is then sealed with a second end 47b at a side seam area (not shown).

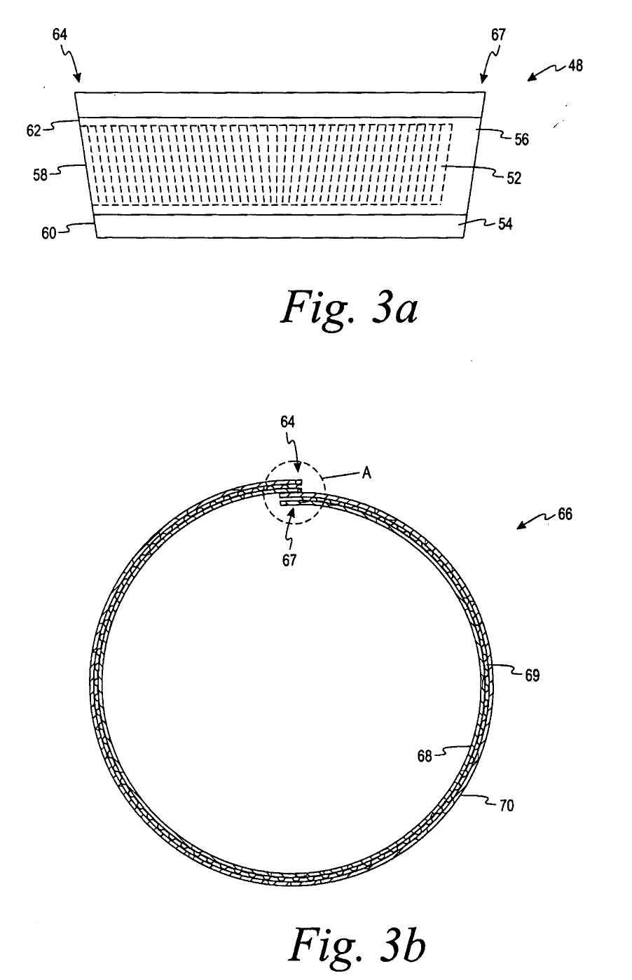

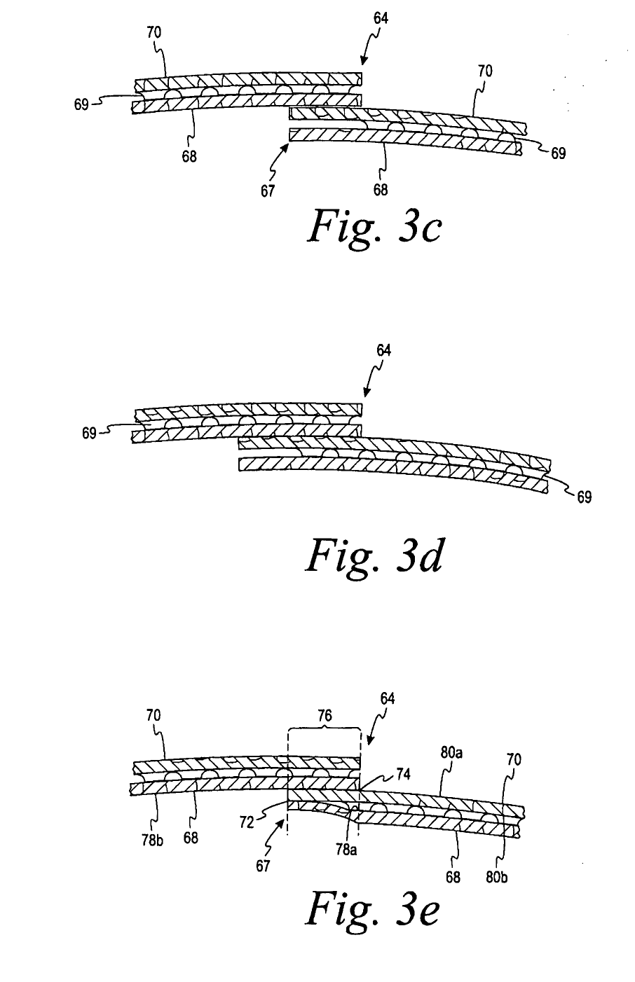

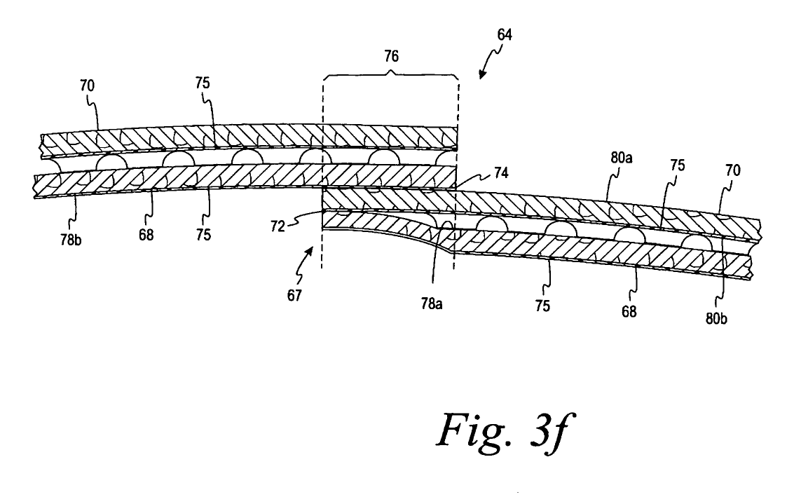

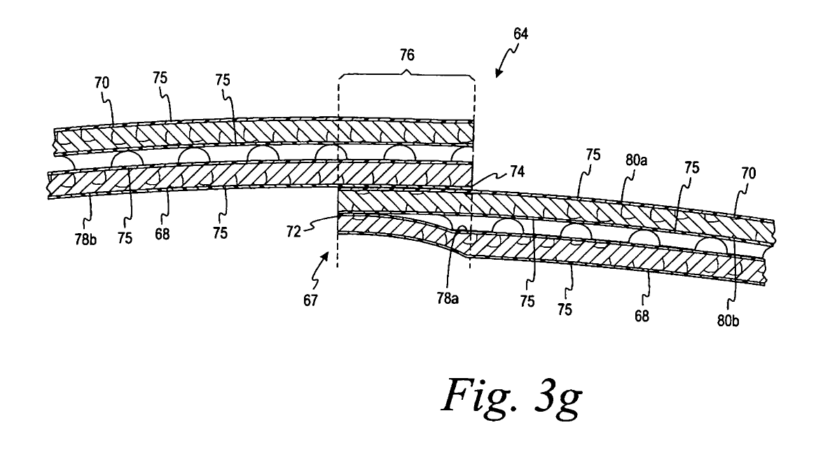

FIG. 3a shows a flat three-layered arrangement 48 according to one embodiment of the present invention. The three-layered arrangement 48 of FIG. 3a is similar to that of FIG. 2c. However, the three-layered arrangement 48 of FIG. 3a includes a middle layer blank 52 having a shorter length than an inner layer blank 54 and an outer layer blank 56. The blanks 52, 54, 56 are stacked such that respective first edges 58, 60, 62 of the blanks 52, 54, 56 are generally aligned at a first end 64 of the three-layered arrangement 48.

The middle layer blank 52 may be glued, bonded, or otherwise fastened to either or both the inner layer blank 54 and the outer layer blank 56 as described above with respect to the embodiment of FIGS. 2a-c. Alternatively or additionally, the middle layer blank 52, the inner layer blank 54, and the outer layer blank 56 may be attached at or near the first end 64 (i.e., at or near the respective first edges 58, 60, 62) such that each blank 52, 54, 56 is at least indirectly attached to the other blanks 52, 54, 56.

The three-layered arrangement 48 of FIG. 3a may then be wrapped and assembled into a cup 66 having an inner layer 68 (formed from the inner layer blank 54), a middle layer 69 (formed from the middle layer blank 52), and an outer layer 70 (formed from the outer layer blank 56), as shown in FIGS. 3b, 3c. The wrapping is performed such that the first end 64 (i.e., the first edges 58, 60, 62) is on the outside of the cup 66 and an opposing second end 67 is on the inside of the cup 66. It is contemplated, however, that the wrapping may also be performed such that the first end 64 is on the inside of the cup 66 and the second end 67 is on the outside of the cup 66. Marginal portions of the outer layer 70, the middle layer 69, and the inner layer 68 of the first end 64 overlap marginal portions of the outer layer 70 and the inner layer 68 of the second end 67. Although in the illustrated embodiment, the middle layer 69 does not overlap the first end 64, it is contemplated that a marginal portion of the middle layer 69 may overlap the first end 64, as shown in FIG. 3d. It is contemplated that any suitable wrapping technique may be used.

After the three-layer arrangement 48 has been wrapped, a back side 80b of the outer layer 70 is attached to a front side 78a of the inner layer 68 at a first attachment site 72 located at the second end 67, as shown in FIG. 3e. Additionally, a back side 78b of the inner layer 68 of the first end 64 and a front side 80a of the outer layer 70 at the second end 67 are attached at a second attachment site 74, as shown in FIG. 3e. Thus, a resulting side seam 76 of the embodiment of FIGS. 3a-e generally includes five layers: three layers of the first end 64 (outer layer 70, middle layer 69, and inner layer 68) and two layers of the second end 67 (outer layer 70 and inner layer 68). Therefore, shortening the length of the middle layer blank 52 with respect to the inner layer blank 54 and the outer layer blank 56, as illustrated in FIGS. 3a-e, reduces the thickness of the side seam 76 such that only five layers are present at the side seam 76, instead of six layers, as would be the case if the middle layer blank 52 extended to the second end 67 (see FIGS. 2a-c).

It is contemplated that any suitable attachment method may be used at the first and second attachment sites 72, 74 and the resulting side seam 76 including, but not limited to, adhesive, heat sealing, combinations thereof, or the like. At least one of the surfaces at each of the attachment sites 72, 74 has an adhesive or a coating applied thereon such that a seal may be formed. Coating less than all of the sides of the inner layer 68 and/or the outer layer 70 may be desirable to reduce costs of manufacturing and also to make the cup 66 more environmentally friendly. For example, each of the inner layer 68 and the outer layer 70 may include a polyethylene coating on only one of the front side 78a, 80a or the back side 78b, 80b. Because it may be desirable for the back side 78b of the inner layer 68 to include a waterproof coating (because the back side 78b may contact liquid within the cup 66), the back side 78b of the inner layer 68 and the back side 80b of the outer layer 70 may include a polyethylene coating 75, as illustrated in FIG. 3f. Alternatively, only one of the inner layer 68 and the outer layer 70 may include a polyethylene coating on both the front side 78a, 80a and the back side 78b, 80b. It is also contemplated that the inner layer 68 and the outer layer 70 may include a polyethylene coating 75 on both the front sides 78a, 80a and the back sides 78b, 80b, as shown in FIG. 3g.

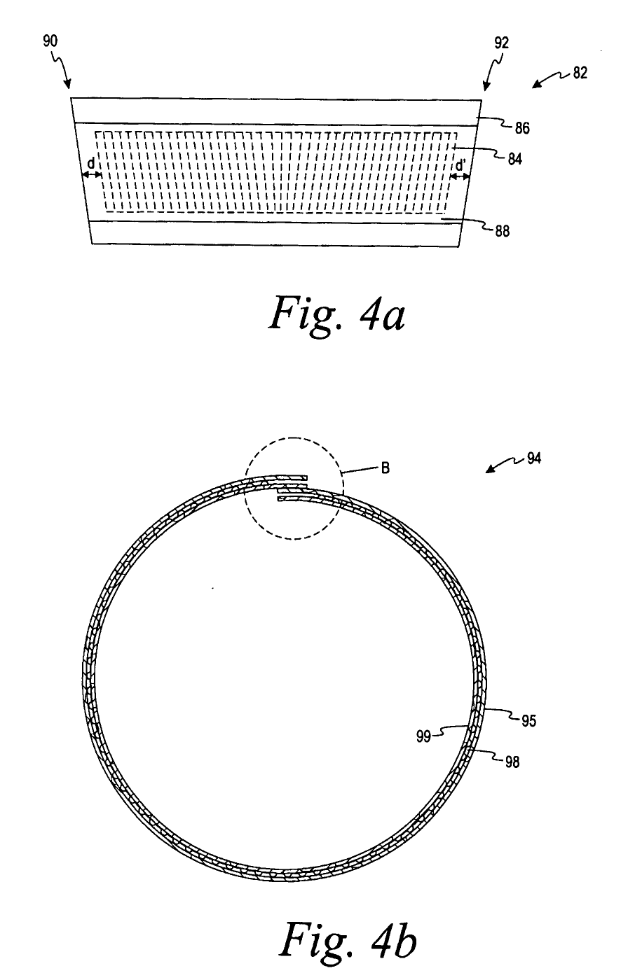

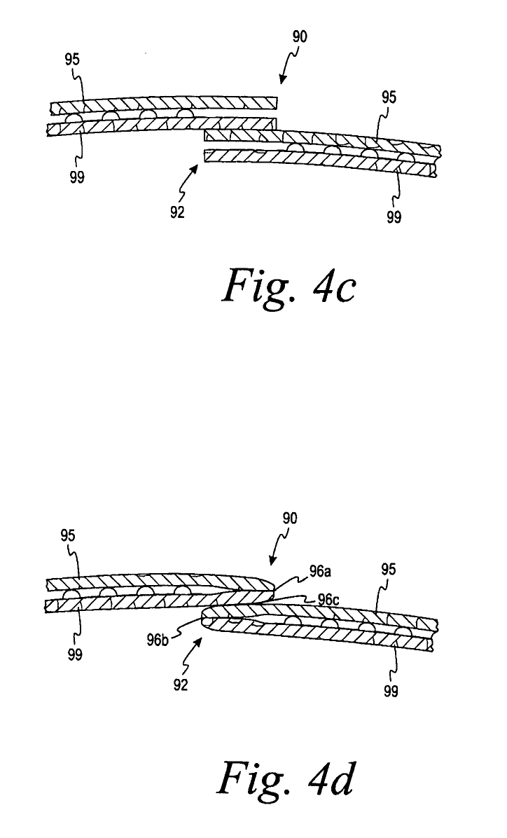

Referring now to the embodiments of FIGS. 4a-d, a flat, three-layered arrangement 82 is shown according to another embodiment of the present invention. The three-layered arrangement 82 is similar in structure to the three-layered arrangement 48 of FIG. 3a in that the three-layered arrangement 82 includes a middle layer blank 84 that is shorter in length than an inner layer blank 86 and an outer layer blank 88. In the embodiment of FIG. 4a, however, the middle layer blank 84 is generally positioned a marginal distance d away from a first end 90 and a marginal distance d′ away from a second end 92. It is contemplated that the distance d may be substantially the same as or different than the distance d′. Although in the embodiments of FIGS. 4a-d, the inner layer blank 84 and the outer layer blank 88 are substantially the same length, it is contemplated that the inner layer blank 84 and the outer layer blank 88 may have different lengths.

The three-layered arrangement 82 may then be attached and wrapped using any suitable techniques, including those described above with respect to FIGS. 2a-c, to form a resulting cup 94, as shown in FIG. 4b. The cup 94 includes an outer layer 95 (formed from the outer layer blank 88), a middle layer 98 (formed from the middle layer blank 84), and an inner layer 99 (formed from the inner layer blank 86).

Referring to FIG. 4c, after the three-layered arrangement 82 is wrapped, a marginal portion of the first end 90 overlaps a marginal portion of the second end 92. The overlapping portion includes four layers: two layers of the first end 90 (i.e., the outer layer 95 and the inner layer 99) and two layers of the second end 92 (i.e., the outer layer 95 and the inner layer 99).

FIG. 4d illustrates one possible way of forming a side seam using the wrapped three-layered arrangement 82 of FIGS. 4a-c. In the embodiment of FIG. 4d, the outer layer 95 and the inner layer 99 of the first end 90 are attached to one another at a first attachment site 96a, and the outer layer 95 and the inner layer 99 of the second end 92 are attached to one another at a second attachment site 96b. The layers 95, 99 of the first end 90 are then attached to the layers 95, 99 of the second end 92 at a third attachment site 96c. It is contemplated that each of the attachment sites 96a-c may be formed simultaneously or separately (in any order).

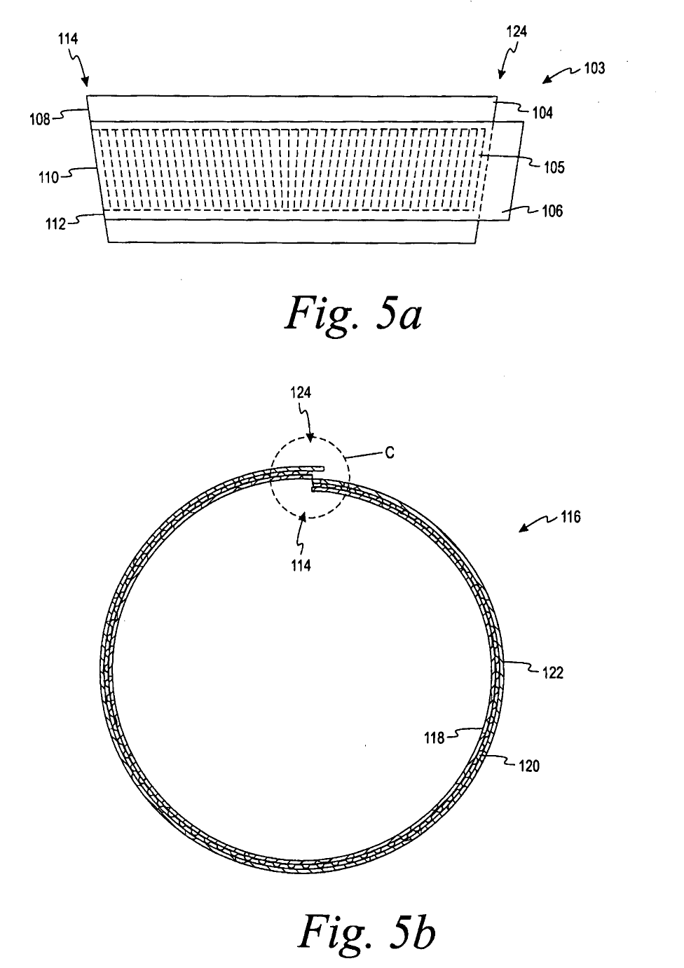

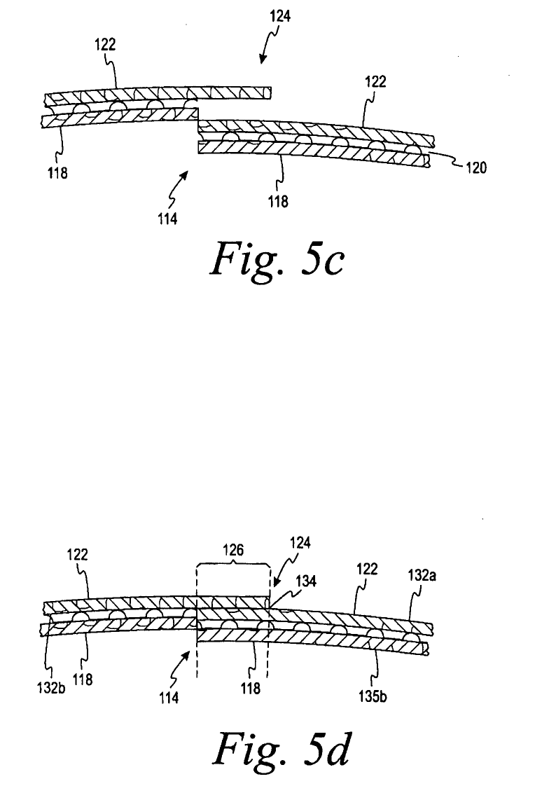

Referring now to FIG. 5a, a flat, three-layered arrangement 103 is shown according to another embodiment of the present invention. The three-layered arrangement 103 includes an inner layer blank 104, a middle layer blank 105, and an outer layer blank 106. In the embodiment of FIGS. 5a-d, the length of the outer layer blank 106 is greater than the length of the inner layer blank 104 and the middle layer blank 105. In the illustrated embodiment, the length of the inner layer blank 104 is substantially the same as the length of the middle layer blank 105. It is also contemplated that the inner layer blank 104 may have a different length than the middle layer blank 105. The blanks 104, 105, 106 are stacked to form the three-layered arrangement 103 such that respective first edges 108, 110, 112 of the blanks 104, 105, 106 are generally aligned at a first end 114 of the three-layered arrangement 103. The blanks 104, 105, 106 may be attached to one another using any suitable method including those described with respect to FIGS. 2a-c.

The three-layered arrangement 103 of FIG. 5a may then be wrapped and assembled into a cup 116 (FIG. 5b) having an inner layer 118 (formed from the inner layer blank 104), a middle layer 120 (formed from the middle layer blank 105), and an outer layer 122 (formed from the outer layer blank 106), as shown in FIG. 5b. The wrapping is performed such that the first end 114 (i.e., the first edges 108, 110, 112) is on the inside of the cup 116 and an opposing second end 124 is on the outside of the cup 116. It is contemplated, however, that the wrapping may also be performed such that the first end 114 is on the outside of the cup 116 and the second end 124 is on the inside of the cup 116. After the three-layered arrangement 103 is wrapped, a marginal portion of the outer layer 122 of the second end 124 overlaps a marginal portion of the layers 118, 120, 122 of the first end 114, as shown in greater detail in FIG. 5c. Thus, the overlapping portion includes four layers: the outer layer 122 of the second end 124 and the outer layer 122, the middle layer 120, and the inner layer 118 of the first end 114. It is contemplated that any suitable wrapping technique may be used, including those described above with respect to FIGS. 2a-c.

The four layers may then be attached to form a side seam 126, as shown in FIG. 5d. More specifically, a back side 132b of the outer layer 122 of the second end 124 may be attached to a front side 132a of the outer layer 122 of the first end 114 at an attachment site 134. The layers may be attached using any suitable method, including the methods described above with respect to FIGS. 2a-e.

Because there is only one attachment site 134 involving both sides 132a,b of the outer layer 122 in the embodiment of FIGS. 5a-d, it would be sufficient for either the front side 132a or the back side 132b of the outer layer 122 to include an adhesive or a coating to form the side seam 126. According to another embodiment, the front side 132a of the outer layer 122 and a back side 135b of the inner layer 118 include, for example, a polyethylene coating. It is contemplated that other surfaces or combinations of surfaces of the inner layer 118 and/or the outer layer 122 may be coated with polyethylene.

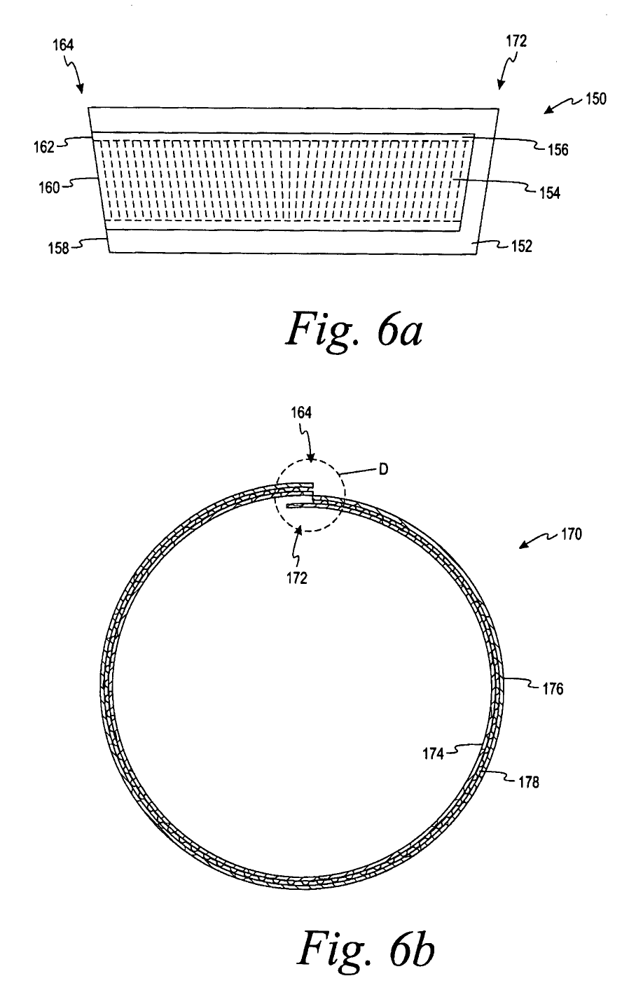

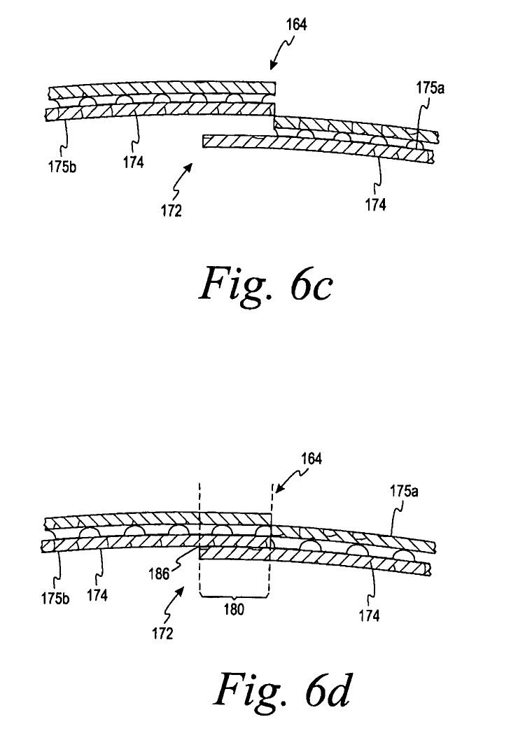

Referring now to FIGS. 6a-d, a flat, three-layered arrangement 150 is shown according to another embodiment of the present invention. The three-layered arrangement 150 includes an inner layer blank 152, a middle layer blank 154, and an outer layer blank 156. In the embodiment of FIGS. 6a-d, the length of the inner layer blank 152 is generally greater than the length of the outer layer blank 156 and the middle layer blank 154. Although in the illustrated embodiment, the middle layer blank 154 and the outer layer blank 156 are substantially the same length, it is contemplated that the middle layer blank 154 and the outer layer blank 156 may have different lengths. The blanks 152, 154, 156 are stacked to form the three-layered arrangement 150 such that respective first edges 158, 160, 162 of the blanks 152, 154, 156 are generally aligned at a first end 164 of the three-layered arrangement 150. The blanks 152, 154, 156 of the three-layered arrangement 150 may be attached using any suitable method including those described with reference to FIGS. 2a-c.

The three-layered arrangement 150 of FIG. 6a may then be wrapped and assembled into a cup 170 (FIG. 6b) having an inner layer 174 (formed from the inner layer blank 152), a middle layer 176 (formed from the middle layer blank 154), and an outer layer 178 (formed from the outer layer blank 156), as shown in FIG. 6b. The wrapping is performed such that the first end 164 (i.e., the first edges 158, 160, 162) is on the outside of the cup 170 and an opposing second end 172 is on the inside of the cup 170. It is contemplated, however, that the wrapping may also be performed such that the first end 164 is on the inside of the cup 170 and the second end 172 is on the outside of the cup 170. It is contemplated that any suitable wrapping technique may be used including those described above with respect to FIGS. 2a-c.

After the three-layered arrangement 150 is wrapped, marginal portions of the layers 174, 176, 178 of the first end 164 overlap a marginal portion of the inner layer 174 of the second end 172. Thus, the overlapping portion includes four layers: the outer layer 178, the middle layer 176, and the inner layer 174 of the first end 164 and the inner layer 174 of the second end 172. The four layers may then be attached to form a side seam 180, as shown in FIG. 6d. More specifically, a back side 175b of the inner layer 174 of the first end 164 is attached to a front side 175a of the inner layer 174 of the second end 172 at an attachment site 186 (FIG. 6d). The layers may be attached using any suitable methods including the methods described above with respect to FIGS. 2a-e.

Because there is only one attachment site 186 in the embodiment of FIGS. 6a-d, it would be sufficient for either the front side 175a or the back side 175b of the inner layer 174 to include an adhesive or a coating to form the side seam 180. It may be desirable, for example, for a polyethylene coating to be located on the back side 175a of the inner layer 174 to waterproof the interior surface of the cup 170. It is contemplated that other surfaces or combinations of surfaces of the inner layer 174 and/or the outer layer 178 may be coated with polyethylene.

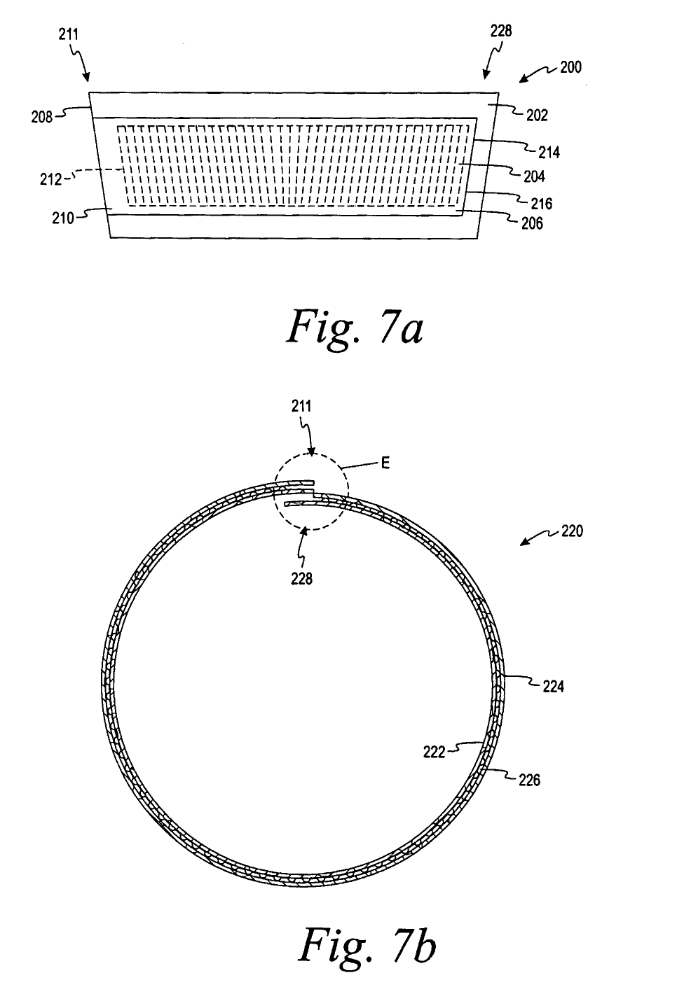

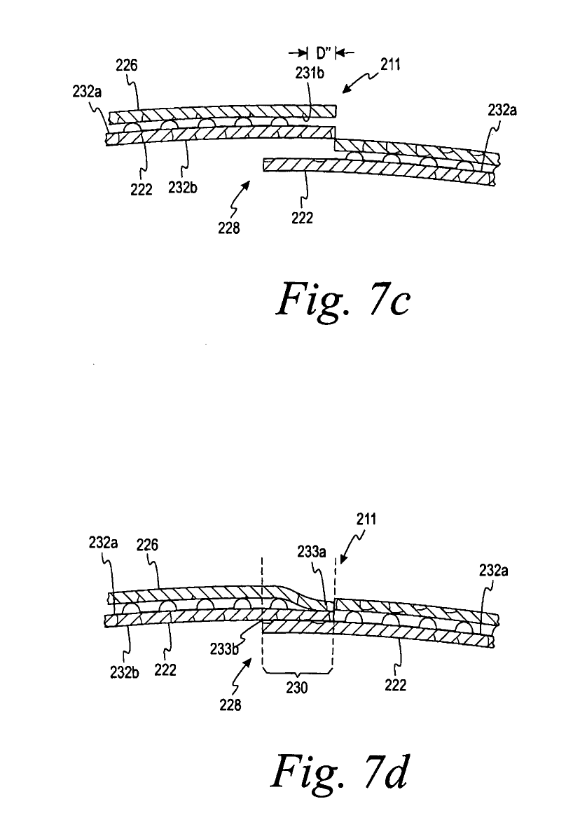

Referring now to FIGS. 7a-d, a flat, three-layered arrangement 200 is shown according to another embodiment of the present invention. The three-layered arrangement 200 includes an inner layer blank 202, a middle layer blank 204, and an outer layer blank 206. In the embodiment of FIGS. 7a-d, the length of the inner layer blank 202 is generally greater than the length of the outer layer blank 206 and the middle layer blank 204. Furthermore, the outer layer blank 206 is longer than the middle layer blank 204. The inner layer blank 202 and the outer layer blank 206 are stacked such that a first edge 208 of the inner layer blank 202 is generally aligned with a first edge 210 of the outer layer blank 206 at a first end 211 of the three-layered arrangement 200. The middle layer blank 204 is stacked such that a first edge 212 of the middle layer blank 204 is offset from the first edges 208, 210 of the inner layer blank 202 and the outer layer blank 206. An opposing second edge 214 of the middle layer blank 204 is generally aligned with a second edge 216 of the outer layer blank 206. The blanks 202, 204, 206 of the three-layered arrangement 200 may be attached using any suitable method including those described with reference to FIGS. 2a-c.

The three-layered arrangement 200 of FIG. 7a may then be wrapped and assembled into a cup 220 (FIG. 7b) having an inner layer 222 (formed from the inner layer blank 202), a middle layer 224 (formed from the middle layer blank 204), and an outer layer 226 (formed from the outer layer blank 206), as shown in FIG. 7b. The wrapping is performed such that the first end 211 (i.e., the first edges 208, 210, 212) is on the outside of the cup 220 and an opposing second end 228 is on the inside of the cup 220. It is contemplated, however, that the wrapping may also be performed such that the first end 211 is on the inside of the cup 220 and the second end 228 is on the outside of the cup 220. It is contemplated that any suitable wrapping techniques may be used including those described above with respect to FIGS. 2a-c.

After the three-layered arrangement 200 of FIG. 7a is wrapped, marginal portions of the outer layer 226 and the inner layer 222 of the first end 211 overlap a marginal portion of the inner layer 222 of the second end 228, as shown in FIG. 7c. Thus, the overlapping portion includes three layers: the outer layer 226 and the inner layer 222 of the first end 211 and the inner layer 222 of the second end 228. The three layers may then be attached to form a side seam 230, as shown in FIG. 7d. More specifically, a back side 231b of the outer layer 226 of the first end 211 is attached to a front side 232a of the inner layer 222 of the first end 211 at a first attachment site 233a. A back side 232b of the inner layer 222 of the first end 211 is attached to a front side 232a of the inner layer 222 of the second end 228 at a second attachment site 233b. The layers may be attached using any suitable methods including the methods described above with respect to FIGS. 2a-e. Depending on the distance D″ of the middle layer 226 from the first end 211 of the cup 220, the slope of the outer layer 226 at the first end 211 after being sealed may be small and/or gradual. Furthermore, the outer layer 226 of the first end 211 is in generally the same plane as the outer layer 226 of the second end 228, which may be desirable to create a smooth surface at or near the side seam 230.

As described above, at least one of the surfaces at each of the attachment sites 233a, 233b includes an adhesive or a coating applied thereon such that a generally leak-proof seal may be formed. Thus, each of the inner layer 222 and the outer layer 226 of FIGS. 7a-d may include a polyethylene coating on both the front sides 231a, 232a and the back sides 231b, 232b. Alternatively, each of the inner layer 222 and the outer layer 226 may be coated with polyethylene on only one side 231a, 232a, 231b, 232b. According to one non-limiting example, a back side 231b of the outer layer 226 and a back side 232b of the inner layer 222 are coated with polyethylene. It is contemplated that other surfaces or combinations of surfaces of the inner layer 222 and/or the outer layer 226 may be coated with polyethylene.

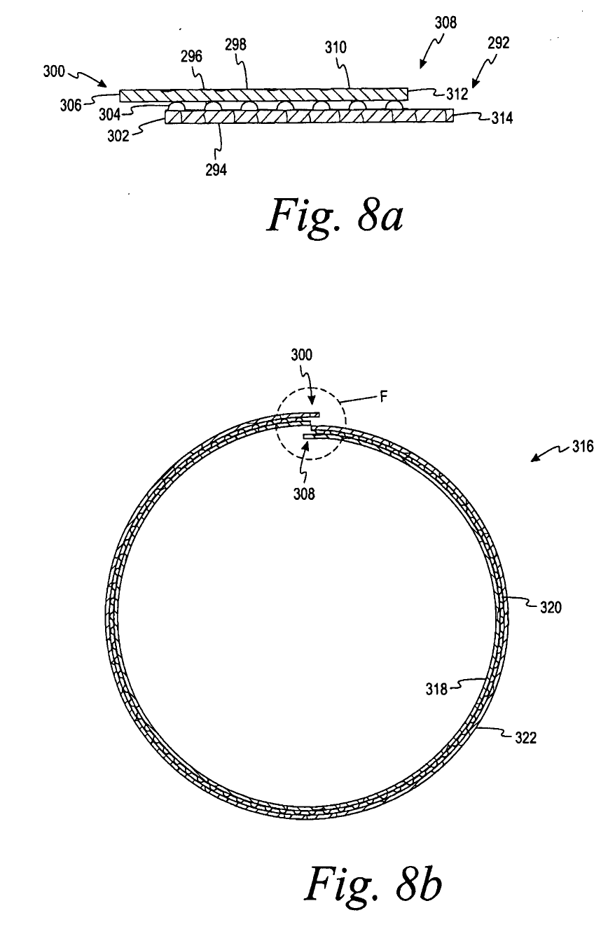

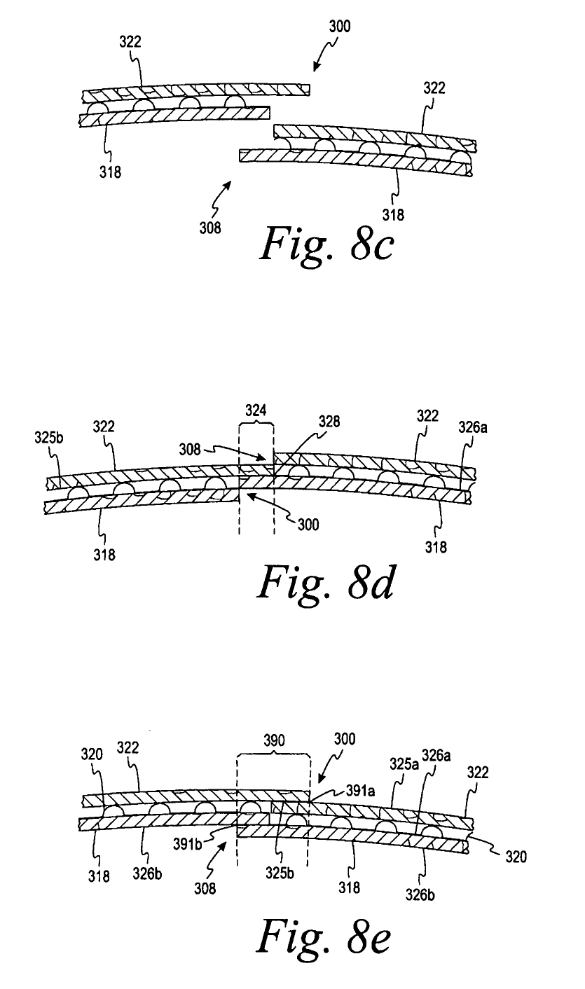

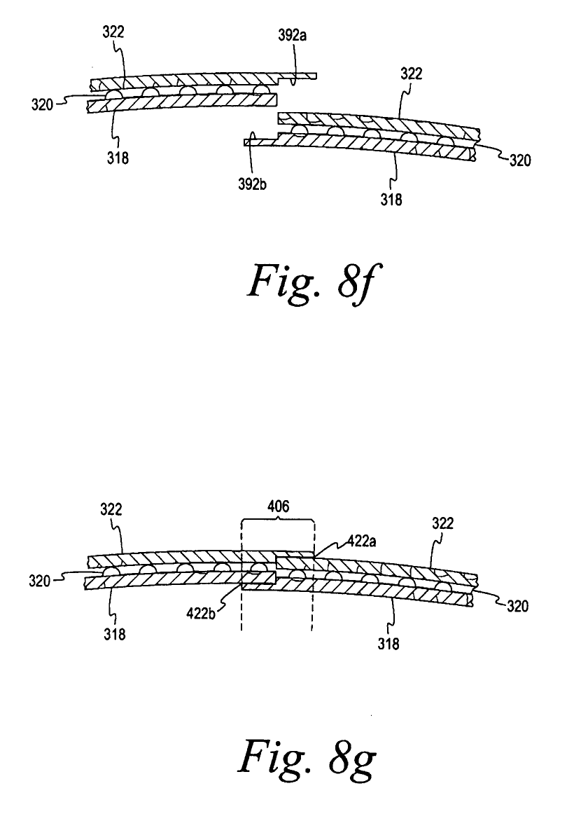

Referring now to FIGS. 8a-f, a flat, three-layered arrangement 292 is shown according to another embodiment of the present invention. The three-layered arrangement 292 includes an inner layer blank 294, a middle layer blank 296, and an outer layer blank 298. In the embodiment of FIGS. 8a-f, the length of the middle layer blank 296 is generally smaller than the length of the inner layer blank 294 and the outer layer blank 298. Although in the illustrated embodiment, the inner layer blank 294 and the outer layer blank 298 are substantially the same length, it is contemplated that the inner layer blank 294 and the outer layer blank 298 may have different lengths.

At a first end 300 of the three-layered arrangement 292, the inner layer blank 294 and the middle layer blank 296 are stacked such that a first edge 302 of the inner layer blank 294 is generally aligned with a first edge 304 of the middle layer blank 296. A first edge 306 of the outer layer blank 298 extends past the first edges 302, 304 of the inner layer blank 294 and the middle layer blank 296 at the first end 300. At an opposing second end 308, a second edge 310 of the middle layer blank 296 is generally aligned with a second edge 312 of the outer layer blank 298. A second edge 314 of the inner layer blank 294 extends past the second edges 310, 312 of the middle layer blank 296 and the outer layer blank 298 at the second end 308. The blanks 294, 296, 298 of the three-layered arrangement 292 may be attached using any suitable technique including those described above with respect to FIGS. 2a-c.

The three-layered arrangement 292 of FIG. 8a may then be wrapped and assembled into a cup 316 (FIG. 8b) including an inner layer 318 (formed from the inner layer blank 294), a middle layer 320 (formed from the middle layer blank 296), and an outer layer 322 (formed from the outer layer blank 298). The wrapping is performed such that the first end 300 is on the outside of the cup 316 and an opposing second end 308 is on the inside of the cup 316. It is contemplated, however, that the wrapping may also be performed such that the first end 300 is on the inside of the cup 316 and the second end 308 is on the outside of the cup 316. It is contemplated that any suitable wrapping technique may be used including those described with respect to FIGS. 2a-c.

Referring to FIG. 8d, after the three-layered arrangement 292 is wrapped, a marginal portion of the outer layer 322 of the first end 300 overlaps a marginal portion of the inner layer 318 of the second end 308. Thus, the overlapping portion includes two layers. The two layers may then be attached to form a side seam 324, as shown in FIGS. 8d. More specifically, a back side 325b of the outer layer 322 of the first end 300 may be attached to a front side 326a of the inner layer 318 of the second end 308 at an attachment site 328. The two layers may be attached using any suitable method, including the methods described above with respect to FIGS. 2a-e.

Referring now to an alternative embodiment of FIG. 8e, after the three-layered arrangement 308 is wrapped, a marginal portion of the outer layer 322 of the first end 300 overlaps a marginal portion of the layers 318, 320, 322 of the second end 308. Likewise, a marginal portion of the inner layer 318 of the second end 308 overlaps a marginal portion of the layers 318, 320, 322 of the first end 300. Thus, the embodiment of FIG. 8e includes two overlapping portions each having four layers. A first overlapping portion includes the outer layer 322 of the first end 300 and the outer layer 322, the middle layer 320, and the inner layer 318 of the second end 308. The second overlapping portion includes the outer layer 322, the middle layer 210, and the inner layer 318 of the first end 300 and the inner layer 318 of the second end 308. The layers may then be attached to form a side seam 390, as shown in FIG. 8e. More specifically, the back side 325b of the outer layer 322 of the first end 300 may be attached to a front side 325a of the outer layer 322 of the second end 308 at a first attachment site 391a. A back side 326b of the inner layer 318 of the first end 300 is attached to a front side 326a of the inner layer 318 of the second end 308 to form a second attachment site 391b. The layers may be attached using any suitable method, including the methods described above with respect to FIGS. 2a-e.

As described above, at least one of the surfaces at each of the attachment sites 328, 391a,b includes an adhesive or a coating applied thereon such that a seal may be formed. Thus, at least one of the back side 325b of the outer layer 322 and the front side 326a of the inner layer 318 may be coated with, for example, polyethylene. Because it may be desirable for a back side 326b of the inner layer 318 to include a waterproof coating, it is contemplated that both the front side 326a and the back side 326b of the inner layer 318 may include a polyethylene coating. It is contemplated that other surfaces or combinations of surfaces of the inner layer 318 and/or the outer layer 322 may be coated with polyethylene.

According to another embodiment of the present invention, the thickness of the side seam may be reduced by using a skiving (thinning or shaving) unit to slice or shave a predetermined thickness off of a marginal portion of the inner layer and/or the outer layer at an attachment site(s) prior to wrapping. The thickness of the skived portion is generally between about 10% to about 90% and, more specifically, between about 25% to about 75% of the total thickness of the inner layer and/or outer layer. Although such a skiving technique may be applied to any of the embodiments of the present invention, the technique is illustrated in FIGS. 8f, 8g using the three-layered arrangement 292 of FIG. 8a. Thus, referring to FIG. 8a, the thickness of a portion(s) of the inner layer blank 294 and/or a portion(s) of the outer layer blank 298 that forms at least a part of the side seam (e.g., side seams 324, 390) is reduced. Reduced areas 392a,b are shown in FIGS. 8f and 8g. The reduced areas 392a,b are located at a first and second attachment site 402a,b.

As described above, at least one of the surfaces at each of the attachment sites 402, 404 has an adhesive applied thereon such that a seal may be formed. Thus, it may be desirable that the surface(s) not including adhesive be skived such that a sufficient amount of adhesive remains at the attachment sites 402a,b to create a side seam 406 including a generally leak-proof seal.

Referring back to FIG. 1, in order to finish the cup 10, an upper edge 49a of the inner layer 24 is rolled radially outward to form a rim. The embodiment of FIG. 1 (or a similar embodiment), where the inner layer 24 extends past an upper edge 51a of the outer layer 26, may be desirable to facilitate the rolling process. The bottom 11 is attached to the inner layer 24, and a lower edge 49b of the inner layer 24 is folded inward and heat sealed to the bottom 11. It may be desirable for the inner layer 24 to extend past a lower edge 51b of the outer layer 26 to facilitate sealing and attaching the bottom 11. It is contemplated that various suitable methods of forming and sealing the rim and the bottom of the cup 10 may be used.

The materials, relative sizes, arrangements, and the like of the parts of the cups of the embodiments of the present invention may be varied. For example, the heights of the inner layer, the middle layer, and the outer layer of the embodiments of the present invention may vary relative to one another. Furthermore, as shown in the illustrated embodiments, the middle layer and/or the outer layer may extend substantially around the entire circumference of the cup. Alternatively, the middle layer blank and/or the outer layer blank may have a shorter length, thereby extending around less than the entire circumference of the cup. These variations may be desirable to save paper and materials without significantly affecting the insulating performance of the cup. Additionally, it is contemplated that mirror-image embodiments of the three-layered arrangements of the illustrated embodiments may also be used in accordance with the present invention. It is also contemplated that the blanks, layers, and/or ends of the respective three-layered arrangements and/or cups of the present invention may be attached and/or sealed in any order.

The containers and cups of the present invention have many benefits over existing cups. For example, the cups of the present invention are generally leak resistant and have excellent thermal insulating properties. Additionally, the cups may be formed on existing cup machinery, resulting in high production speeds and low manufacturing costs. Moreover, the cups of the present invention have surfaces that are conducive to printing with sharp and crisp graphics.

As a consequence of using three separate layers to form the containers and cups of the present invention, a manufacturer may have the ability to alter the various thicknesses and materials of the layers to achieve the desired cup properties including insulating ability, weight, strength, percentage of recyclable materials, cost of materials, and the like. For example, the amount of recycled materials used in manufacturing the cups of the embodiments of the present invention may be optimized by varying the amounts of recycled material used to manufacture each of the inner layer, the middle layer, and the outer layer as necessary. Because the blanks of the present invention are not formed from a single sheet, the waste associated with the material removed from the portion of the single sheet surrounding the shortened middle layer and/or outer layer may be minimized or eliminated. This is particularly applicable in embodiments where the height of the middle layer and/or the outer layer is smaller than the height of the inner layer. Furthermore, in embodiments where it is desirable to print a “legend” in the inner ring of the bottom of the cup, the present invention only requires one-sided printing.

According to alternative embodiment A, a thermally insulated container comprises an inner layer having a bottom portion with a bottom closure attached to the bottom portion, an outer layer wrapped around the inner layer, an insulating middle layer sandwiched between the inner layer and the outer layer, and a side seam including five or less layers, wherein at least one of the layers of the side seam is an end of the middle layer.

According to alternative embodiment B, the container of alternative embodiment A, wherein the container is a cup.

According to alternative embodiment C, the container of alternative embodiment A, wherein the middle layer is attached to at least one of the inner layer and the outer layer.

According to alternative embodiment D, the container of alternative embodiment A, wherein the middle layer includes spaced grooves formed in a surface thereof, said spaced grooves running substantially from a top edge to a bottom edge of the middle layer.

According to alternative embodiment E, the container of alternative embodiment A, wherein each of the inner layer and the outer layer includes a front side and a back side, at least one of the front side and back side of at least one of the inner layer and the outer layer including a polyethylene coating.

According to alternative embodiment F, the container of alternative embodiment A, further comprising a bottom blank attached to at least the inner layer to form a bottom of the container.

According to alternative embodiment G, the container of alternative embodiment A, wherein the height of the middle layer is smaller than the height of the inner layer.

According to alternative embodiment H, the container of alternative embodiment A, wherein the plurality of layers includes between three and five layers.

According to alternative embodiment I, the container of alternative embodiment A, wherein at least one of the layers of the side seam is skived.

According to alternative process J, a method of making a thermally insulated container, comprises the acts of providing a bottom blank, an inner layer, an outer layer, and a middle layer, the middle layer comprising an insulating sheet material, stacking the inner layer, the outer layer, and the middle layer such that the middle layer is sandwiched between the inner layer and the outer layer to form a layered arrangement, the layered arrangement having a first end and an opposing second end, wrapping the layered arrangement such that the first end overlaps the second end to form an overlapping portion, and sealing at least part of the overlapping portion to form a side seam having five or less layers, wherein at least one of the layers of the side seam is an end of the middle layer.

According to alternative process K, the method of alternative process J, further including attaching the middle layer to at least one of the inner layer and the outer layer.

According to alternative process L, the method of alternative process J, wherein the middle layer is attached to at least one of the inner layer and the outer layer by applying adhesive periodically along a length of at least one of the inner layer, the middle layer, and the outer layer.

According to alternative process M, the method of alternative process J, wherein each of the inner layer and the outer layer includes a front side and a back side, at least one of the front side and the back side of at least one of the inner layer and the outer layer including a polyethylene coating.

According to alternative process N, the method of alternative process J, wherein the act of sealing includes applying pressure to the overlapping area to form a heat seal.

According to alternative process O, the method of alternative process J, further comprising forming each of the inner layer, the outer layer, and the middle layer from three separate sheets of material.

According to alternative process P, the method of alternative process J, wherein the container is a cup, the method further comprising the act of rolling a top portion of at least the inner layer radially outward to form a rim.

According to alternative process Q, the method of alternative process P further comprising attaching at least the inner layer to the bottom blank to form a bottom of the cup.

According to alternative process R, the method of alternative process J, wherein the overlapping portion includes between three and five layers.

According to alternative process S, the method of alternative process J further comprising skiving at least a portion of at least one of the layers at the overlapping portion.

According to alternative embodiment T, a thermally insulated container comprises an inner layer having a bottom portion with a bottom closure attached to said bottom portion, an outer layer wrapped around said inner layer, an insulating middle layer sandwiched between the inner layer and the outer layer, and a side seam comprising five or less layers, wherein at least one end of the outer layer is sealed with at least one end of the inner layer at the side seam.

According to alternative embodiment U, the container of alternative embodiment T, wherein the middle layer extends around the entire container.

According to alternative embodiment V, the container of alternative embodiment T, wherein the middle layer extends around less than the entire container.

According to alternative embodiment W, the container of alternative embodiment T, wherein at least one of the inner layer and the outer layer is skived at the side seam.

According to alternative embodiment X, a thermally insulated container comprises an inner layer having a bottom portion with a bottom closure attached to the bottom portion, an outer layer wrapped around the inner layer, an insulating middle layer sandwiched between the inner layer and the outer layer, and a side seam including six layers, the six layers comprising a first end and a second end of the inner layer, a first end and a second end of the middle layer, and a first end and a second end of the outer layer.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention.

What is claimed is:

1. A thermally insulated container comprising:
an inner layer having a bottom portion with a bottom closure attached to the bottom portion;
an outer layer wrapped around the inner layer;
an insulating middle layer sandwiched between the inner layer and the outer layer; and
a side seam including five or less layers, wherein at least one of the layers of the side seam is an end of the middle layer.

2. The container of claim 1, wherein the container is a cup.

3. The container of claim 1, wherein the middle layer is attached to at least one of the inner layer and the outer layer.

4. The container of claim 1, wherein the middle layer includes spaced grooves formed in a surface thereof, said spaced grooves running substantially from a top edge to a bottom edge of the middle layer.

5. The container of claim 1, wherein each of the inner layer and the outer layer includes a front side and a back side, at least one of the front side and back side of at least one of the inner layer and the outer layer including a polyethylene coating.

6. The container of claim 1, further comprising a bottom blank attached to at least the inner layer to form a bottom of the container.

7. The container of claim 1, wherein the height of the middle layer is smaller than the height of the inner layer.

8. The container of claim 1, wherein the plurality of layers includes between three and five layers.

9. The container of claim 1, wherein at least one of the layers of the side seam is skived.

10. A method of making a thermally insulated container, the method comprising the acts of:
providing a bottom blank, an inner layer, an outer layer, and a middle layer, the middle layer comprising an insulating sheet material;
stacking the inner layer, the outer layer, and the middle layer such that the middle layer is sandwiched between the inner layer and the outer layer to form a layered arrangement, the layered arrangement having a first end and an opposing second end;
wrapping the layered arrangement such that the first end overlaps the second end to form an overlapping portion; and
sealing at least part of the overlapping portion to form a side seam having five or less layers, wherein at least one of the layers of the side seam is an end of the middle layer.

11. The method of claim 10, further including attaching the middle layer to at least one of the inner layer and the outer layer.

12. The method of claim 10, wherein the middle layer is attached to at least one of the inner layer and the outer layer by applying adhesive periodically along a length of at least one of the inner layer, the middle layer, and the outer layer.

13. The method of claim 10, wherein each of the inner layer and the outer layer includes a front side and a back side, at least one of the front side and the back side of at least one of the inner layer and the outer layer including a polyethylene coating.

14. The method of claim 10, wherein the act of sealing includes applying pressure to the overlapping area to form a heat seal.

15. The method of claim 10, further comprising forming each of the inner layer, the outer layer, and the middle layer from three separate sheets of material.

16. The method of claim 10, wherein the container is a cup, the method further comprising the act of rolling a top portion of at least the inner layer radially outward to form a rim.

17. The method of claim 16 further comprising attaching at least the inner layer to the bottom blank to form a bottom of the cup.

18. The method of claim 10, wherein the overlapping portion includes between three and five layers.

19. The method of claim 10 further comprising skiving at least a portion of at least one of the layers at the overlapping portion.

20. A thermally insulated container comprising:
an inner layer having a bottom portion with a bottom closure attached to said bottom portion;
an outer layer wrapped around said inner layer;
an insulating middle layer sandwiched between the inner layer and the outer layer; and
a side seam comprising five or less layers, wherein at least one end of the outer layer is sealed with at least one end of the inner layer at the side seam.

21. The container of claim 20, wherein the middle layer extends around the entire container.

22. The container of claim 20, wherein the middle layer extends around less than the entire container.

23. The container of claim 20, wherein at least one of the inner layer and the outer layer is skived at the side seam.

24. A thermally insulated container comprising:
an inner layer having a bottom portion with a bottom closure attached to the bottom portion;
an outer layer wrapped around the inner layer;
an insulating middle layer sandwiched between the inner layer and the outer layer; and
a side seam including six layers, the six layers comprising a first end and a second end of the inner layer, a first end and a second end of the middle layer, and a first end and a second end of the outer layer.
